(19) United States
(12) Patent Application Publication
(10) Pub. No.: US 2010/0017573 A1
(43) Pub. Date: Jan. 21, 2010

(54) STORAGE SYSTEM, COPY CONTROL METHOD OF A STORAGE SYSTEM, AND COPY CONTROL UNIT OF A STORAGE SYSTEM

(75) Inventors: Yoshinari Shinozaki, Kawasaki (JP); Koji Uchida, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/495,288

(22) Filed: Jun. 30, 2009

(30) Foreign Application Priority Data
Jul. 15, 2008 (JP) 2008-183555

(51) Int. Cl. G06F 12/16; G06F 12/00

(52) U.S. Cl. 711/162; 711/E12.001; 711/E12.103

(57) ABSTRACT

A storage system and a copy control method enabling copying of data stored in a first volume connected with a higher-level device to a second volume. The system and method include controlling an update using a first management table for managing an update during a period from reception of a copy instruction from the higher-level device to reception of a predetermined command, and transferring update data of the first volume to the second volume based on the update situation in the first management table.

### CROSS-REFERENCE TO RELATED APPLICATIONS

This application claims the benefit of Japanese Application No. 2008-183555, filed on Jul. 15, 2008, in the Japan Patent Office, the disclosure of which is incorporated herein by reference.

### FIELD

The present invention relates to a copying technique in association with a storage system, more particularly, to a system including a plurality of storage devices (storage volumes), and copying data for backup and mirroring between the plurality of storage volumes.

### BACKGROUND

Hitherto, in the field of disk array devices such as devices based on Redundant Arrays of Inexpensive Disks (RAID), there is a technique for copying data to another disk array device, which is constituted in the form of another housing, to perform operations such as duplexing (synchronization; Equivalent Copy) of the data for backup and mirroring.

The duplexing of data is performed in accordance with an instruction from a host that is a higher-level device with respect to the disk array device. One example of a copying method is an asynchronous method of replying with a completion report in response to the instruction, which is issued from the host for duplexing (copying), to the host at once in an asynchronous relation to the completion of actual duplexing, and then executing the actual duplexing (see, e.g., Japanese Laid-open Patent Publication No. 7-262070 and Japanese Laid-open Patent Publication No. 2001-134482).

Generally, there are two modes of asynchronous copying (i.e., asynchronous REC (Remote Equivalent Copy) function), namely, a stack mode and a consistency mode.

In the stack mode, when a write operation to a copy source is completed, an updated portion is recorded and a response to the write operation is returned to the host. Data transfer to a copy destination is not executed during an I/O process, such as the write operation, and is executed in a copy data transfer process that is operated in the background. Because the copy data transfer process is executed regardless of I/O processes (hereinafter also simply called the “I/O's”) from the host, the sequence of write operations to a copy destination volume is not ensured in the stack mode.

In the consistency mode, a buffer for holding copy data is provided in units of control module, and when a write operation to the copy source is completed, the copy data is temporarily stored in the buffer. After lapse of a certain time or when the buffer is filled with data, the data is transferred to the copy destination in units equal to that of the buffer, and the transferred data is reflected upon corresponding areas of the copy destination in the sequence in which the data has been stored. Accordingly, the sequence of write operations to the copy destination is ensured in the consistency mode.

Thus, the consistency mode is generally considered superior to the stack mode as a copy technique for mirroring because the sequence of write operations to the copy destination, i.e., the sequence in which data is reflected upon the copy destination, is ensured in the consistency mode.

In the consistency mode, however, the amount of data transferred from a copy source to a copy destination is changed depending on the I/O amount (amount of write operations) with respect to the copy source. Therefore, the bandwidth of a remote line required between housings needs to be prepared based on bandwidth matching the data transfer amount.

Further, in the consistency mode, the capacity of the buffer for temporarily accumulating the I/O's issued to the copy source is required to be set in estimation of the I/O amount with respect to the copy source. Hence, the consistency mode poses problems in various aspects from the viewpoint of system design.

On the other hand, the stack mode is advantageous in that because the copy data transfer process independently functions in an asynchronous relation to the I/O's, the buffer is not required and the copy data transfer process is not affected by the line condition.

Recovery to be made when a disk array device at the copy source has failed during copying (i.e., during transfer of copy data) can be more easily executed in the consistency mode than the stack mode for the reason that data is transmitted in the consistency mode while the sequence is ensured in units of buffer. Stated another way, in the stack mode, because the sequence of write operations is not ensured as described above, what state the copy destination takes is not ensured in the event of a failure during the data transfer.

Thus, the stack mode and consistency mode have respective advantages and disadvantages.

### SUMMARY

A copy control method of a storage system, and a copy control unit in the storage system is provided. An update control section controls update with respect to a first volume in accordance with an update instruction for the first volume from a higher-level device using a first management table for managing an update situation of the first volume during a period from receipt of a copy instruction from the higher-level device to reception of a predetermined command (update control), and a transfer control section transfers update data of the first volume to a second volume based on the update situation in the first management table (transfer control). Further, the update control section controls, upon receiving the predetermined command, the update with respect to the first volume using, instead of the first management table, a second management table for managing an update situation of the first volume after the reception of the predetermined command (update control).

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram showing a configuration of a storage system according to an embodiment of the present invention.

FIG. 2 is a block diagram showing a configuration of a copy control unit in a storage system according to an embodiment of the present invention.

FIG. 3 is a flowchart showing one example of operation procedure(s) of a copy control unit when a disk array device in a storage system according to an embodiment of the present invention receives a copy instruction from a host.

FIG. 4 is an explanatory view illustrating preparing and initializing a first bitmap and a second bitmap, which is executed by a disk array device in a storage system according to an embodiment of the present invention; more specifically, FIG. 4A illustrates a schematic configuration of a storage system in executing process(es), and FIG. 4B illustrates respective examples of the first bitmap and the second bitmap, which are prepared and initialized.

FIG. 5 is an explanatory view illustrating an ordinary copy process before a check point is applied from a host to a disk array device in a storage system according to an embodiment of the present invention; more specifically, FIG. 5A illustrates a schematic configuration of a storage system in executing that process, and FIG. 5B illustrates respective one examples of a first bitmap and a second bitmap in that process.

FIG. 6 is a flowchart showing one example of an operation procedure(s) of a copy control unit when a disk array device in a storage system according to an embodiment of the present invention receives a check point from a host.

FIG. 7 is an explanatory view illustrating a process executed when a disk array device in a storage system according to an embodiment of the present invention receives a check point from a host; more specifically, FIG. 7A illustrates a schematic configuration of the storage system in executing that process, and FIG. 7B illustrates respective one examples of a first bitmap and a second bitmap in that process.

FIG. 8 is a flowchart showing one example of an operation procedure(s) of a copy control unit when an update process with respect to a copy source storage area during transfer is executed in a disk array device in a storage system according to an embodiment of the present invention.

FIG. 9 is a flowchart showing one example of an operation procedure(s) of a copy control unit when a check point state is confirmed from a host in a disk array device in a storage system according to an embodiment of the present invention.

FIG. 10 is an explanatory view illustrating a process executed when a disk array device in a storage system according to an embodiment of the present invention receives, from a host, a command for confirming whether copying up to a check point is completed.

FIG. 11 is a flowchart showing one example of an operation procedure(s) of a storage system when copying of data as a transfer target of a check point is completed in a disk array device in a storage system according to an embodiment of the present invention.

FIG. 12 is an explanatory view illustrating a process executed by a copy control unit when copying of data as a transfer target of a check point is completed in a disk array device in a storage system according to an embodiment of the present invention.

FIG. 13 is an explanatory view showing respective one examples of a first bitmap and a second bitmap when copying of data as a transfer target of a check point is completed in a disk array device in a storage system according to an embodiment of the present invention; more specifically, FIG. 13A illustrates a state before information in a second bitmap is merged with information in a first bitmap, and FIG. 13B illustrates a state after the merging.

FIG. 14 is an explanatory view for explaining a process executed when, after completion of copying of data as a transfer target of a check point, the disk array device in a storage system according to an embodiment of the present invention receives, from a host, a command for confirming whether copying up to the check point is completed.

FIG. 15 is an explanatory view for illustrating a process of updating a management file in a disk array device, which is executed by a host in a storage system according to an embodiment of the present invention.

FIG. 16 is an explanatory view for illustrating a process of transferring a management file between disk array devices in a storage system according to an embodiment of the present invention.

FIG. 17 is a flowchart showing one example of an operation procedure(s) of a storage system when a disk array device at a copy destination in a storage system according to an embodiment of the present invention receives a read request for a copy destination storage area from a host.

FIG. 18 is a flowchart showing one example of an operation procedure(s) of a copy control unit when an update process with respect to a copy source storage area during transfer is executed in a disk array device in a storage system according to an embodiment of the present invention.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

The present invention has been accomplished in view of the above-mentioned and/or other problems, and an object of the present invention is to, when data is copied for duplexing of the data between (among) a plurality of storage areas (e.g., a plurality of disk array devices), eliminate the need for intricacy in system design, enable data to be transferred without being affected by the line condition, and facilitate recovery in the event of a failure, etc.

In accordance with the storage system, a copy control method for the storage system, and a copy control unit in the storage system, a first management table to be used before reception of a predetermined command and a second management table to be used after the reception of the predetermined command are prepared. More specifically, a transfer control section executes the data transfer in accordance with the copy instruction from the higher-level device on the basis of the first management table. Further, upon receiving the predetermined command, the update control section controls the update with respect to the first volume by using the second management table instead of the first management table.

Therefore, when data is copied between a plurality of volumes including for a purpose of duplexing of the data, a guarantee of the copied data can be reliably ensured on the basis of the predetermined command. Hence, recovery can be easily performed in the event of a failure, etc.

Also, since the copy process (data transfer) is executed on the basis of the first management table and the second management table, the copy process can be executed in an asynchronous relation to I/O's from the higher-level device, and the data transfer can be performed without being affected by the line condition. In addition, since there is no need of using a buffer dedicated for the copy process, which is required in the consistency mode, intricacy in system design is not required.

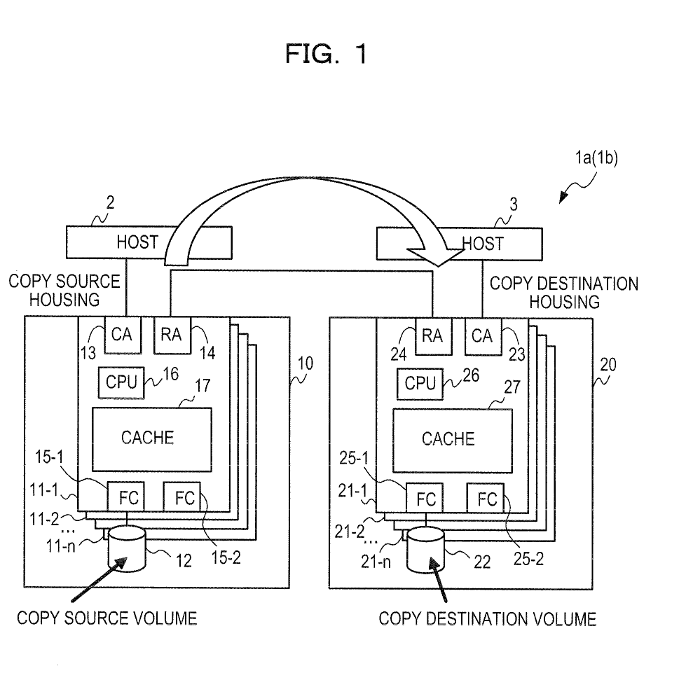

Initially, a storage system 1a according to an embodiment of the present invention (hereinafter referred to as a “present storage system 1a”) is described with reference to a block diagram shown in FIG. 1. The present storage system 1a is constituted by two disk array devices (e.g., RAID-based devices) 10 and 20 which are connected respectively with hosts 2 and 3 serving as higher-level devices.

It is here assumed that the disk array device 10 is a copy source housing and the disk array device 20 is a copy destination housing.

Each of the disk array devices 10 and 20 has a plurality of control units (denoted by “CMs (Centralized Modules)”, hereinafter simply called “CMs”) 11-1 to 11-n and 21-1 to 21-n (n=three or more integer).

CMs 11-1 to 11-n and 21-1 to 21-n (hereinafter called “CM 11 and 21” respectively when discrimination between the individual modules is not needed) execute processing for disk drives 12 and 22 in response to an I/O request(s) (such as access requests; read/write requests) from corresponding hosts 2 and 3 which process data held in the disk drives 12 and 22 connected respectively to the CM 11 and 21.

Although one disk drive 12 and 22 are each shown in FIG. 1 with respect to the disk array devices 10 and 20 for the sake of simplicity, plural disk drives 12 and plural disk drives 22 are actually connected with the CMs 11 and 21, respectively, corresponding to fibre channels (described later).

Each CM 11 and 21 includes, respectively, a Channel Adapter (hereinafter simply called a “CA”) 13 and 23, a Remote Adapter (hereinafter simply called an “RA”) 14 and 24, Fibre Channels (hereinafter simply called “FCs”) 15-1, 15-2 and 25-1, 25-2, and a Central Processing Unit (hereinafter simply called a “CPU”) 16 and 26, and a cache memory (denoted by “Cache” in the drawing) 17 and 27.

The CAs 13 and 23 execute interface control between the host 2 and the CM 11 and between the host 3 and the CM 21, respectively.

The RAs 14 and 24 execute interface control between the disk array devices 10 and 20.

The FCs 15-1 and 15-2 and the FCs 25-1 and 25-2 (hereinafter called “FC 15 and FC 25” respectively when discrimination between the individual channels is not needed) execute interface control between the CM 11 and the disk drive 12 and between the CM 21 and the disk drive 22, respectively.

Each of the CPUs 16 and 26 serves to execute data processing.

Each of the cache memories 17 and 27 serves to store user data and control data.

The present storage system 1a copies data located in a predetermined copy (duplexing) target area in a predetermined disk of the disk array device 10 to a predetermined area in a predetermined disk of the disk array device 20 at the copy destination automatically or in response to an instruction from the host 2.

To describe here outline of copy control in the present storage system 1a, the present storage system 1a applies a check point (check point instruction command) to the copy source during copying of data for duplexing and confirms whether data is copied until the check point, thus making it possible to confirm whether the data being copied is reflected upon the copy destination.

In more detail, the present storage system 1a executes data transfer by a transfer method similar to the above-mentioned stack mode. To ensure the data transfer until the check point, two bitmaps are prepared for copy control. One bitmap (later-described as a first bitmap 31) is used for management of update data until immediately before the check point is applied, and the other bitmap (later-described as a second bitmap 32) is used for management of update data after the application of the check point. After the check point has been issued, data transfer until the check point and confirmation of the data transfer are realized by executing the data transfer on the basis of the former bitmap. Management of data update during the data transfer is executed on the basis of the latter bitmap. Accordingly, when data recovery is required, the recovery can be performed until the check point up to which the data transfer is confirmed.

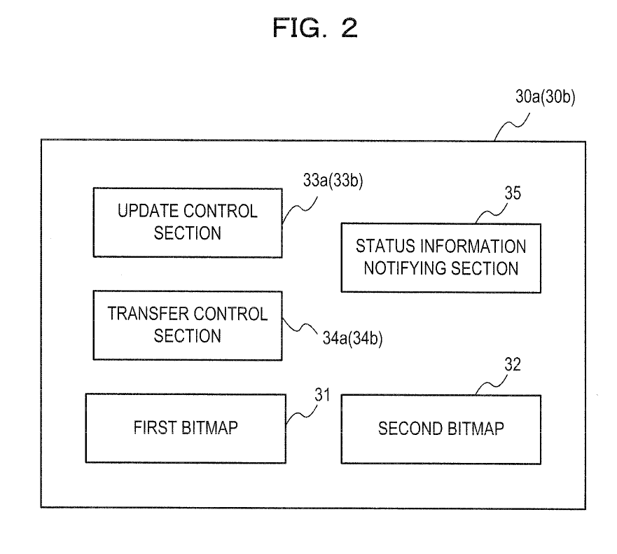

FIG. 2 illustrates a functional block diagram of a copy control unit 30a provided in the CM 11 of the disk array device 10 of the present storage system 1a. The disk array device 20 at the copy destination may also include a copy control unit 30a. However, that copy control unit 30a is not used while the disk array device 20 functions as the copy destination, and it is used when the disk array device 20 functions as the copy source.

As shown in FIG. 2, the copy control unit 30a controls copying of data in a predetermined copy (duplexing) target area, which is stored in a predetermined storage area (a copy source storage area; a first volume) of the disk drive 12 in the disk array device 10, to a predetermined storage area (a copy destination area; a second volume) of the disk drive 22 in the disk array device 20. The copy control unit 30a includes the first bitmap (a first management table) 31, the second bitmap (a second management table) 32, an update control section 33a, a transfer control section 34a, and a status information notifying section 35.

The copy control unit 30a is realized in the disk array device 10 with the CPU 16 and the cache memory 17, and it is realized in the disk array device 20 with the CPU 26 and the cache memory 27.

More specifically, the first bitmap 31 and the second bitmap 32 are realized with the cache memories 17 and 27, respectively. The update control section 33a, the transfer control section 34a, and the status information notifying section 35 are realized with each of the CPU 16 and 26. Alternatively, the update control section 33a, the transfer control section 34a, and the status information notifying section 35, as well as an update control section 33b and a transfer control section 34b in an embodiment described below, may be realized by each of the CPU 16 and 26 executing predetermined software (e.g., a copy control program described below).

The first bitmap 31 and the second bitmap 32 correspond respectively to the copy source storage area and the copy destination storage area in corresponding one of the disk drives 12 and 22. In other words, one data (“0” or “1”) on the first bitmap 31 and the second bitmap 32 correspond respectively to predetermined portions in the copy source storage area and the copy destination storage area. All data on the first bitmap 31 and all data on the second bitmap 32 correspond respectively to the entire copy source storage area and the entire copy destination storage area.

The first bitmap 31 manages the update state of data in the copy source storage area in the disk drive 12 during a period from startup of a copy process (Remote Equivalent Copy (REC)) of data, which is executed for backup or mirroring in response to a copy (duplexing) instruction from the host 2, to reception of the check point from the host 2, or during a period from reception of one check point to reception of another check point when the another check point is received after receiving the one check point.

Herein, a portion of the first bitmap 31 corresponding to a copy source storage area where the copy process is not yet completed, or a portion thereof corresponding to a copy source storage area where data is updated, is set to “1”, and a portion of the first bitmap 31 corresponding to a copy source storage area where the copy process is completed is set to “0”.

The contents of the first bitmap 31 and the second bitmap 32 are controlled by the update control section 33a.

The second bitmap 32 manages the update state of data in the copy destination storage area in the disk drive 12 during a period from reception of one check point from the host 2 to reception of a next check point.

Herein, a portion of the second bitmap 32 corresponding to a copy destination storage area where data is updated is set to “1”, and a portion thereof corresponding to a copy destination storage area where data is not updated is set to “0”.

Details of the update control section 33a, the transfer control section 34a, and the status information notifying section 35 are described below in connection with the case where those sections are provided in the disk array device 10.

The update control section 33a controls, in accordance with an update instruction (a write request) for the copy source storage area from the host 2, an update with respect to the copy source storage area during a period after reception of a copy instruction (REC instruction) from the host 2 to reception of the check point by using the first bitmap 31.

Also, upon receiving the check point, the update control section 33a controls update with respect to the copy source storage area by using the second bitmap 32 instead of the first bitmap 31.

Further, the update control section 33a controls data in the first bitmap 31 and the second bitmap 32.

More specifically, when an update (a write process) is executed on the copy source storage area before receiving the check point, the update control section 33a updates, to “1”, a location on the first bitmap 31 corresponding to the location on the copy source storage area where the update has been executed.

Also, when update is executed on the copy source storage area after receiving the check point, the update control section 33a updates, to “1”, a location on the second bitmap 32 corresponding to the location on the copy source storage area where the update has been executed.

In addition, when an update instruction is issued again on a transfer target area of the copy source storage area from the host 2 after receiving the check point, the update control section 33a executes an update process for the transfer target area of the copy source storage area while the corresponding location on the second bitmap 32 is maintained at “0”.

Each of the first bitmap 31 and the second bitmap 32 includes status information. The status information contains at least a first status indicating a state during copying (during data transfer), a second status indicating a state after completion of the copying (completion of the data transfer), and a third status indicating a state of not receiving (non-receipt) the copy instruction from the host 2.

The update control section 33a changes the status information of the first and second bitmaps 31 and 32.

For example, upon receiving the check point from the host 2, the update control section 33a changes the status information of the first bitmap 31 and the second bitmap 32 to the first status. Further, when the data transfer based on the first bitmap 31 is completed, the update control section 33a changes the status information of the first bitmap 31 and the second bitmap 32 to the second status.

When receiving the check point from the host 2 during a period in which the status information represents the first status, the update control section 33a merges information in the second bitmap 32 into the first bitmap 31. Stated another way, the logical sum of respective data in corresponding locations on the second bitmap 32 and the first bitmap 31 is calculated and the calculated result is reflected upon the first bitmap 31. In addition, the second bitmap 32 to the second status is initialized (namely, all locations are set to “0”).

The transfer control section 34a transfers the update data in the copy source storage area to the copy destination storage area on the basis of the update state of the first bitmap 31.

When the status information notifying section 35 receives a transfer situation confirmation command from the host 2 to confirm the transfer situation (status information), a response regarding the transfer situation, which corresponds to the status represented by that status information, is provided to the host 2 on the basis of the status information of the first bitmap 31.

Next, the operation procedure(s) of the present storage system 1a and more practical processing details of various components will be described.

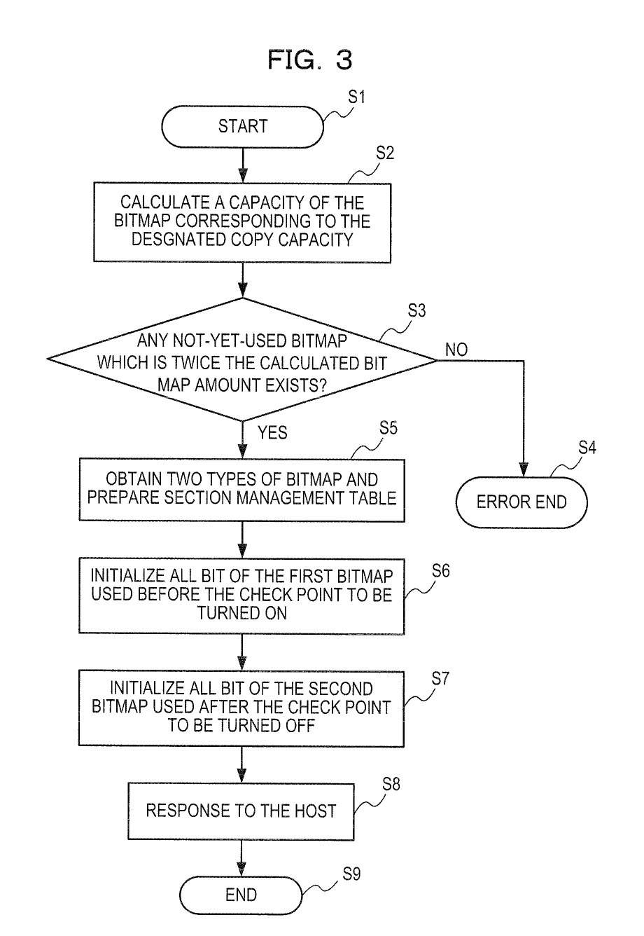

With reference to a flowchart (operations S1 to S9) shown in FIG. 3, a description is first made of the operation procedure(s) of the copy control unit 30a when the disk array device 10 receives the copy instruction (REC instruction) from the host 2.

When preparation of a remote copy session is provided as the copy instruction from the host 2 (operation S1), the update control section 33a calculates a capacity of the bitmap corresponding to the designated copy capacity (operation S2). In other words, the update control section 33a calculates a bitmap amount necessary for the designated copy capacity.

Then, the update control section 33a determines whether the cache memory 17 has a bitmap which is not yet used and which is twice the calculated bitmap amount (operation S3). In other words, the update control section 33a confirms whether a free capacity required for preparing the first bitmap 31 and the second bitmap 32 exists on the cache memory 17.

If the update control section 33a determines that the not-yet-used bitmap does not exist in the required amount (NO route of operation S3), this is regarded as indicating a deficiency of the bitmap capacity and the copy process is brought to an end because of an error (operation S4).

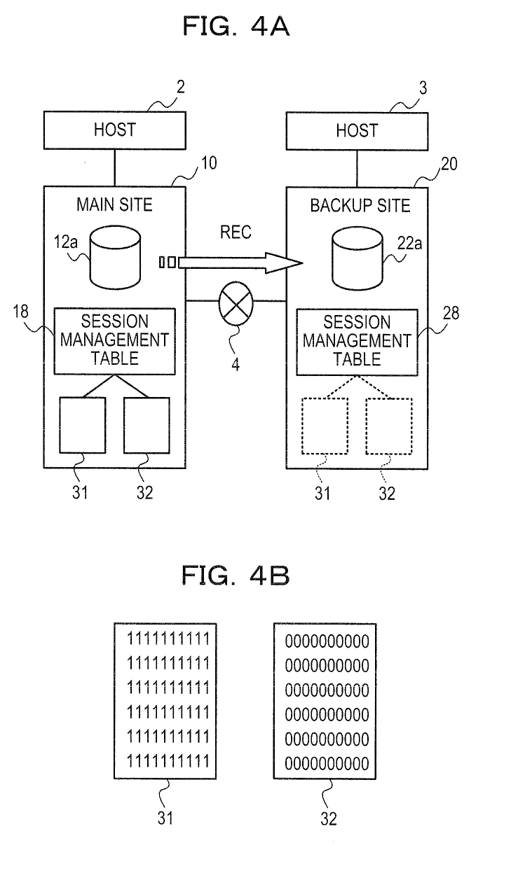

On the other hand, if the update control section 33a determines that the not-yet-used bitmap exists in the required amount (YES route of operation S3), it obtains two types of bitmaps and prepares session management information for the copy process (i.e., a session management table 18 (described below) shown in FIG. 4A) (operation S5).

Then, the update control section 33a initializes all bits of the first bitmap 31 used before the application of the check point to be turned ON (i.e., “1”) (operation S6), and initializes all bits of the second bitmap 32 used after the application of the check point to be turned OFF (i.e., “0”) (operation S7).

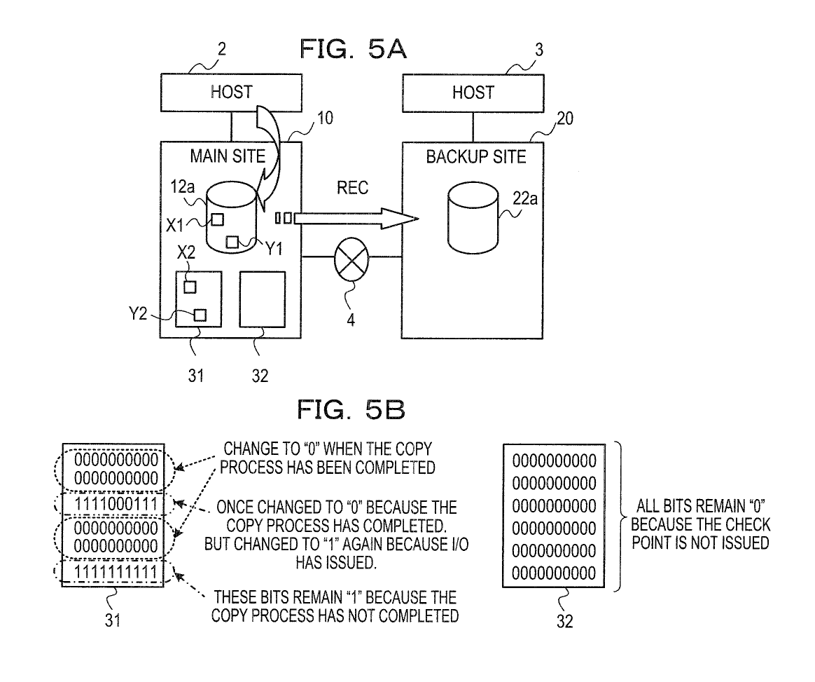

More specifically, as shown in FIG. 4A, the CM 11 in the disk array device 10, which functions as a main site (denoted by “Main Site” in the drawing) of the copy source, prepares not only the session management table 18, but also the first bitmap 31 and the second bitmap 32 in correspondence with the session management table 18 (see operation S5 in FIG. 3). Note that, in FIG. 4A and FIGS. 5A, 7A, 10, 12 and 14 to 16 described below, a character 12a represents the copy source storage area and a character 22a represents the copy destination storage area. Also, a character 4 represents a network used by the RAs 14 and 24 for data transfer data in the copy process.

Similarly to the CM 11, as shown in FIG. 4 A, the CM 12 in the disk array device 20, i.e., the copy destination housing, also prepares a session management table 28, the first bitmap 31, and the second bitmap 32. However, the first bitmap 31 and the second bitmap 32 prepared in the CM 12 are used only when the disk array device 20 becomes the copy source.

Further, as shown in FIG. 4B, the update control section 33a of the disk array device 10 initializes all bits of the first bitmap 31 to “1” (see operation S6 in FIG. 3) and all bits of the second bitmap 32 to “0” (see operation S7 in FIG. 3) so as to provide an initial state.

When the preparation of the remote copy session is requested as an ordinary command from the host 2, the update control section 33a sets an REC session (i.e., the session management table 18) in the above-mentioned stack mode (see operation S5). Note that the check point is managed by the host 2 in units of the session. In other words, when one file is constituted in a state separated into a plurality of volumes, the update control section 33a is required to manage the check point for a plurality of sessions.

When the initialization of the first bitmap 31 and the second bitmap 32 is completed, as shown in FIG. 3, the update control section 33a returns a normal response to the host 2 (operation S8) and brings the process to an end (operation S9).

Next, the ordinary copy process before application of a check point will be described with reference to FIGS. 5A and 5B.

After the update control section 33a replies, as described above, the normal response to the host 2 (see operation S8 in FIG. 3), the transfer control section 34a transfers data in the copy source storage area 12a to the copy destination storage area 22a on the basis of the first bitmap 31.

Then, as shown in FIG. 5B, the update control section 33a changes, to “0”, data in the first bitmap 31 corresponding to a portion in which the copy process by the transfer control section 34a has been completed.

Further, when the write I/O is issued from the host 2 to the disk array device 10 during the copy process, the transfer control section 34a copies data through transfer in the stack mode to locations X1 and Y1 where the data is updated by the issued write I/O.

Also, when the data in the copy source storage area 12a is updated in accordance with the write I/O from the host 2, the update control section 33a changes, to “1”, data at locations X2 and Y2 on the first bitmap 31, which correspond respectively to the updated locations X1 and Y1.

For example, as indicated by “1” in the third line counting from the top of the first bitmap 31 in FIG. 5B, even when the data has been turned off (“0”) with the remote copy transfer, the update control section 33a changes the data at relevant locations on the first bitmap 31 to “1” if the data in the copy source storage area 12a corresponding to the relevant locations is updated.

At that time, all data in the second bitmap 32 remain “0”.

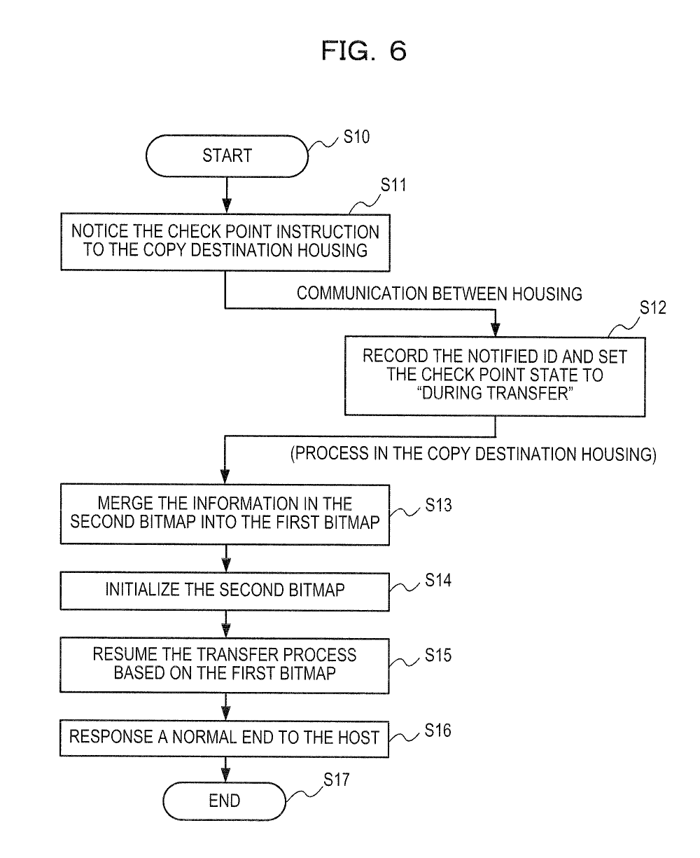

With reference to a flowchart (operations S10 to S17) shown in FIG. 6, a description is next made of the operation procedure(s) of the copy control unit 30a when the check point (check point instruction command) is received from the host 2.

First, upon receiving the check point instruction command from the host 2 (operation S10), the copy control unit 30a communicates (provides) a notice indicating the reception of the check point instruction to the disk array device 20, i.e., the copy destination housing (operation S11).

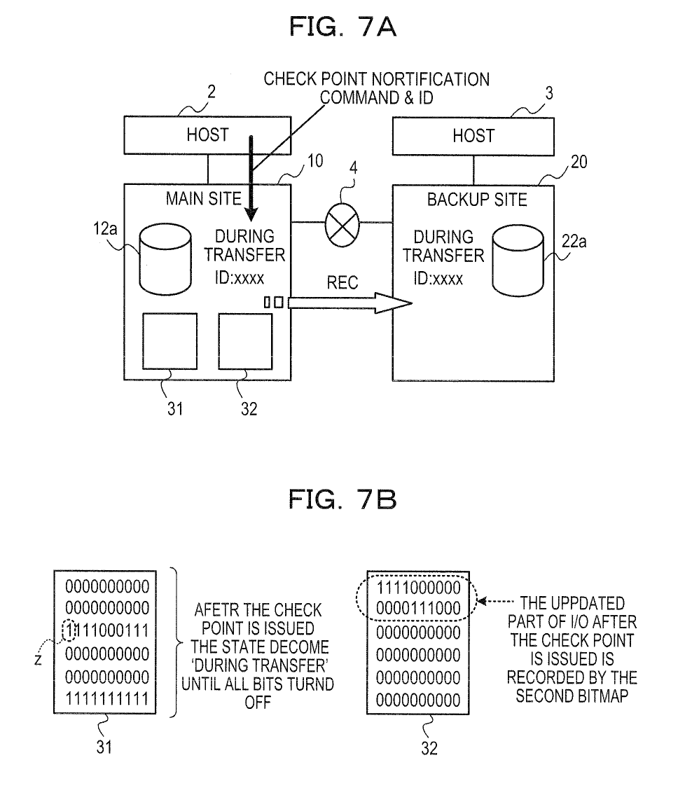

At that time, as shown in FIG. 7A, the update control section 33a provides an ID (Identification) as well, which corresponds to the check point notified from the host 2, to the disk array device 20.

The copy control unit 30a in the disk array device 20 records the notified ID and sets the check point state (status information) to the first status indicating that the state is during transfer (operation S12). Also, as shown in FIG. 7A, the update control section 33a sets the status information in the corresponding to copy control unit 30a to the first status (during transfer).

Then, the update control section 33a of the copy control unit 30a in the disk array device 10 merges the information in the second bitmap 32 into the first bitmap 31 (operation S13). Stated another way, the update control section 33a sets the logical sum of the data of the second bitmap 32 and the data of the first bitmap 31 as data of the first bitmap 31.

Next, the update control section 33a initializes all data of the second bitmap 32 to “0” (operation S14)

Thereafter, the transfer control section 34a resumes the transfer process on the basis of the first bitmap 31 (operation S15), and the copy control unit 30a provides a normal response to the host 2 (operation S16), following which the check point reception process is brought to an end (operation S17).

On that occasion, as shown in FIG. 7B, the update control section 33a manages locations updated with the I/O's from the host 2 after the application (reception) of the check point by using the second bitmap 32. In other words, when data is updated with the I/O's at locations in the copy source storage area 12a corresponding to the locations on the first bitmap 31 for which the completion of transfer (i.e., “0”) is indicated, the update control section 33a changes data at corresponding locations on the second bitmap 32 to “1”.

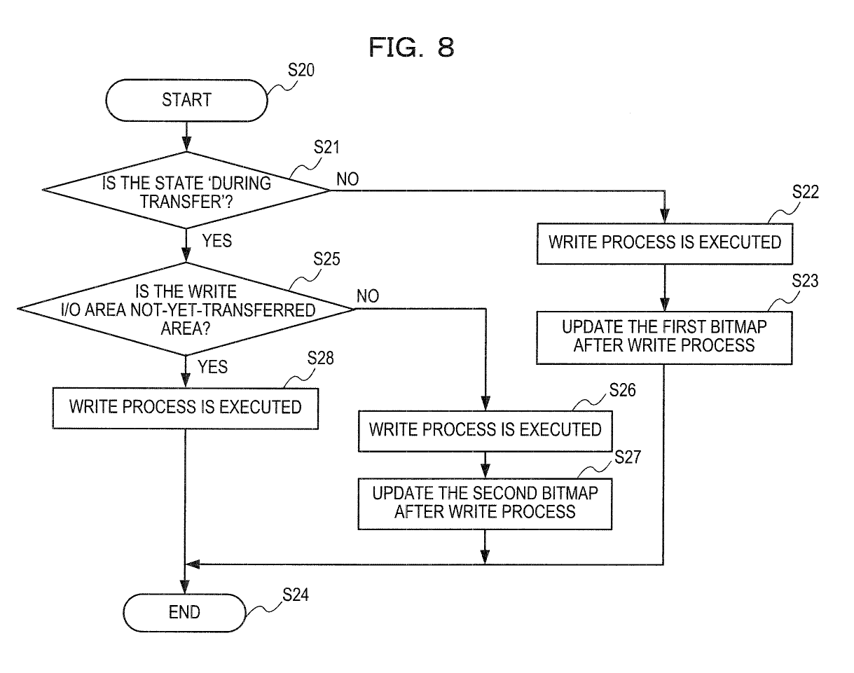

With reference to a flowchart (operations S20 to S28) shown in FIG. 8, a description is now made of the operation procedure(s) of the copy control unit 30a when data is updated with the write I/O for the copy source storage area 12a in the status during transfer (first status).

First, when the CM 11 receives the write I/O from the host 2 (operation S20), the update control section 33a determines whether the state is currently during the transfer (i.e., is there a transfer underway) in accordance with the check point instruction (operation S21).

If the update control section 33a determines that the state is not during the transfer in accordance with the check point instruction (NO route of operation S21), the CPU 16 of the CM 11 sends a write instruction to the host 2, thus causing a write process to be executed (operation S22), and the update control section 33a updates corresponding data in the first bitmap 31 to “1” (operation S23), following which the process for the write I/O is brought to an end (operation S24).

On the other hand, if the update control section 33a determines that the state is during the transfer in accordance with the check point instruction (YES route of operation S21), it determines whether a target area of the write I/O process is a not-yet-transferred area (i.e., a storage area where the copying is completed and corresponding information in the first bitmap 31 is set to “1”) (operation S25).

If the update control section 33a determines on the basis of the first bitmap 31 that bitmap data corresponding to the target area of the write I/O is “0” and does not belong to the not-yet-transferred area (NO route of operation S25), the CPU 16 of the CM 11 sends a write instruction to the host 2, thus causing a write process to be executed (operation S26), and the update control section 33a updates corresponding bitmap data in the second bitmap 32 to “1” (operation S27), following which the process for the write I/O is brought to an end (operation S24).

On the other hand, if the write I/O from the host 2 is instructed for a portion of the copy source storage area 12a corresponding to an area of the first bitmap 31, which is surrounded by a broken line Z, for example, in FIG. 7B and which has data of “1”, the update control section 33a determines on the basis of the first bitmap 31 that the target area of the write I/O is a not-yet-transferred area because the bitmap data corresponding to the target area of the write I/O is “1” (YES route of operation S25).

On that occasion, the CPU 16 of the CM 11 sends a write instruction to the host 2, thus causing a write process to be executed (operation S28), and the process for the write I/O is brought to an end (operation S24).

Stated another way, in that case, the update control section 33a maintains bitmap data in the second bitmap 32 corresponding to the target area of the write I/O as it is without updating the bitmap data to “1”. Of course, the bitmap data in the first bitmap 31 corresponding to the target area of the write I/O is also maintained at “1” as it is.

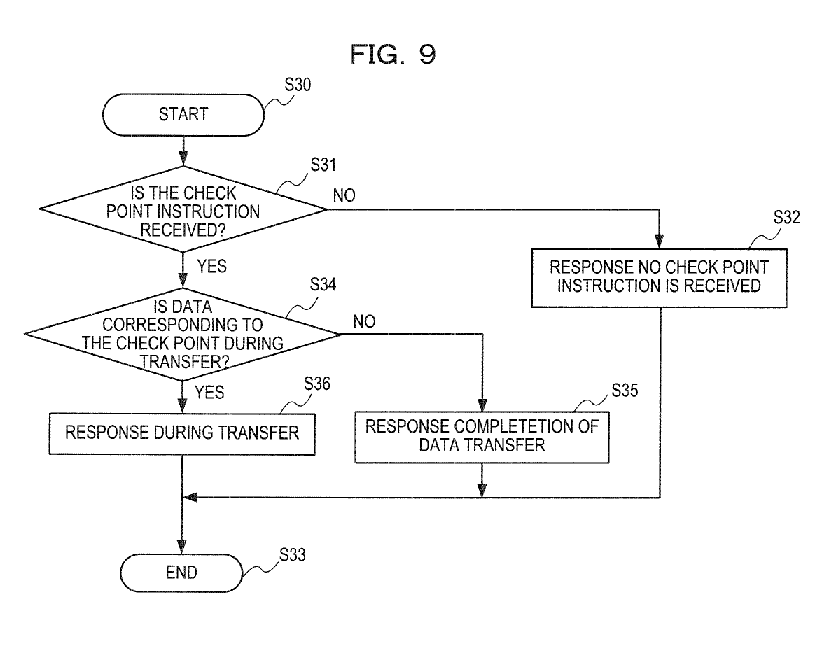

Next, with reference to a flowchart (operations S30 to S36) shown in FIG. 9, a description is made of the operation procedure(s) of the copy control unit when check point state confirmation (i.e., confirmation as to whether copying up to the check point is completed) is executed from the host 2.

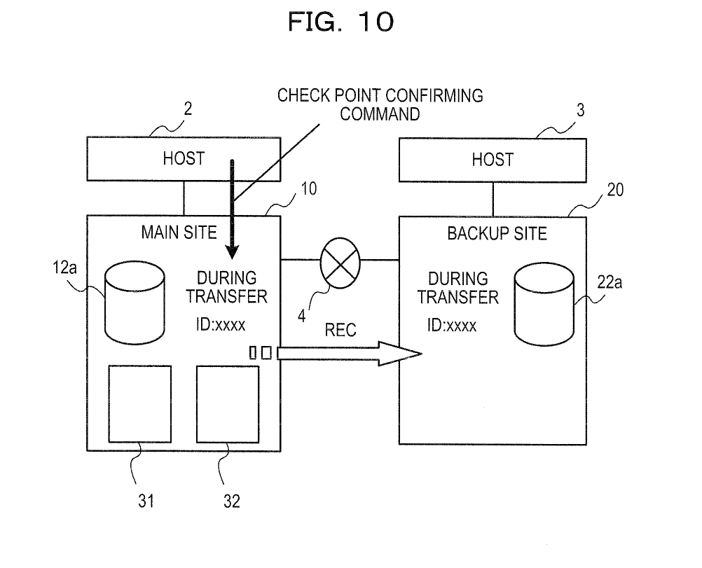

For example, as shown in FIG. 10, when the CM 11 receives a command for confirming whether copying up to the check point applied last from software in the host 2 is completed (operation S30), the status information notifying section 35 determines on the basis of, e.g., the ID of the check point instruction command or the status information whether there is any trace indicating reception of the check point instruction (operation S31).

If the status information notifying section 35 determines that there is no trace indicating the reception of the check point instruction (NO route of operation S31), it provides a notice indicating that no check point instruction has been received to the host 2 (operation S32), following which the process for the confirmation command is brought to an end (operation S33).

On the other hand, if the status information notifying section 35 determines that there is a trace indicating the reception of the check point instruction (YES route of operation S31), it determines on the basis of the status information whether data corresponding to the check point instruction is in the state during transfer (during copying) (operation S34).

If the data is not in the state during copying (NO route of operation S34), i.e., if the status information is in the second status indicating the completion of data transfer, the status information notifying section 35 provides a notice indicating the completion of transfer to the host 2 (operation S35), following which the process for the confirmation command is brought to an end (operation S33).

On the other hand, if the data is still in the state during copying (YES route of operation S34), i.e., if the status information is in the first status indicating the state during data transfer, the status information notifying section 35 provides a notice indicating the state during transfer to the host 2 (operation S36), following which the process for the confirmation command is brought to an end (operation S33).

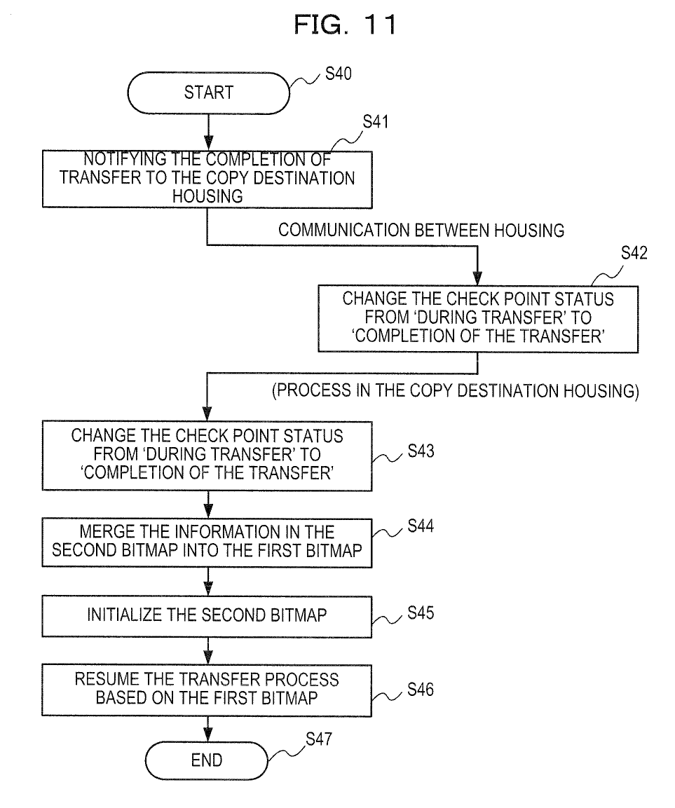

Next, with reference to a flowchart (operations S40 to S47) shown in FIG. 11, a description is made of the operation procedures of the present storage system 1a (FIG. 1) when the copying of data as the transfer target of the check point is completed.

When the copy control unit 30a in the CM 11 detects on the basis of the status information, for example, that data transfer based on the first bitmap 31 after the check point is completed (operation S40), it communicates (provides) a notice indicating the completion of transfer to the copy control unit 30a in the CM 21 of the disk array device 20, i.e., the copy destination housing (operation S41).

Responsively, the update control section 33a of the copy control unit 30a in the CM 21 changes the status information representing the check point state of the relevant copy session from the state during transfer (first status) to the state after the completion of transfer (second status) (operation S42).

Then, the update control section 33a of the copy control unit 30a in the CM 11 changes the status information representing the check point state of the relevant copy session from the state during transfer to the state after the completion of transfer (operation S43).

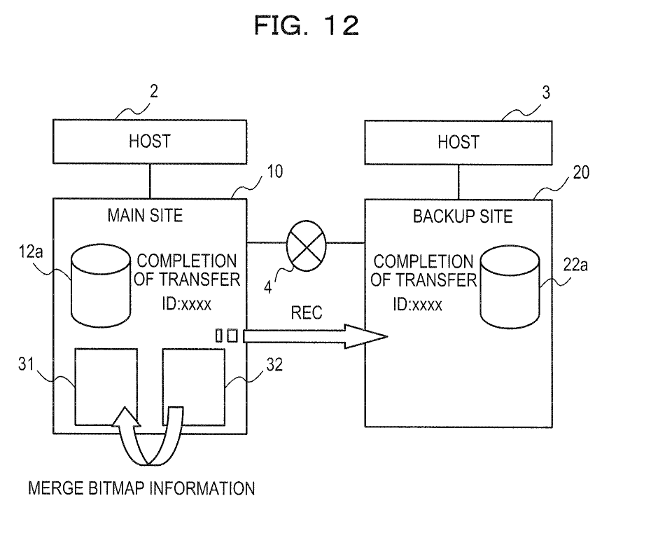

Thus, as shown in FIG. 12, the status information for each of the disk array devices 10 and 20 indicates the state after the completion of transfer (denoted by “Transfer Completed” in the drawing).

Subsequently, the update control section 33a of the CM 11 merges the information in the second bitmap 32 into the first bitmap 31 (operation S44).

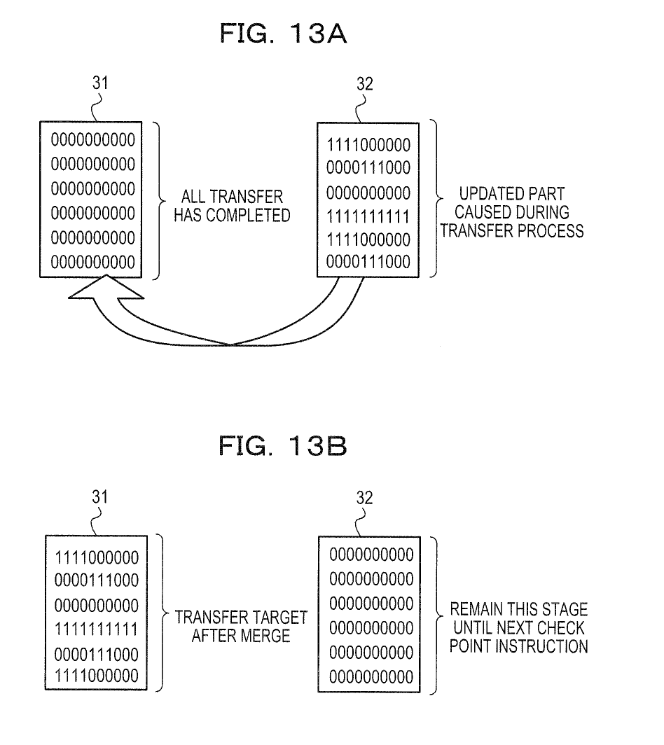

For example, by merging the first bitmap 31 and the second bitmap 32 in the states shown in FIG. 13A with each other, the update control section 33a forms the first bitmap 31 in the state shown in FIG. 13B.

Then, the update control section 33a of the CM 11 initializes the second bitmap 32 as shown in FIG. 13B (operation S45).

Thereafter, the transfer control section 34a of the CM 11 resumes the transfer process on the basis of the first bitmap 31 (operation S46), following which the transfer completion process up to the check point is brought to an end (operation S47).

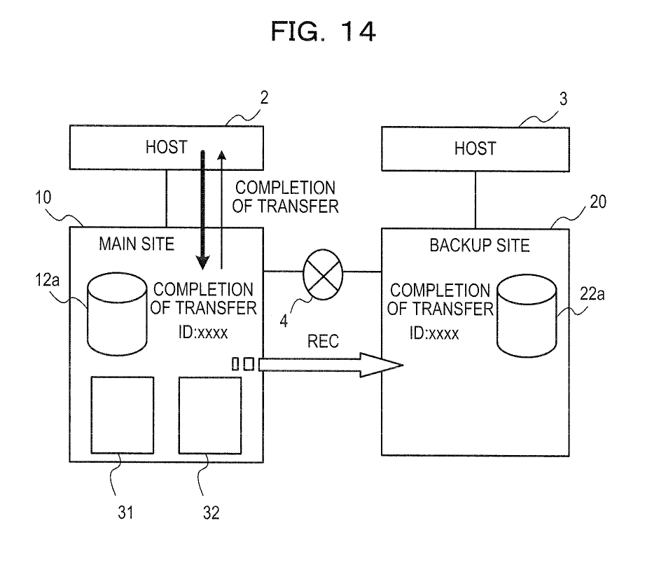

As shown in FIG. 14, when, after the update control section 33a of the CM 11 has changed the status information to the second status, the copy control unit 30a receives a check point confirmation command from the software in the host 2 for confirming whether the copying up to the check point is completed, the status information notifying section 35 provides, to the host 2, a notice indicating the completion of the copying up to the check point. As a result, the software in the host 2 recognizes that the transfer process with respect to the check point has been completed.

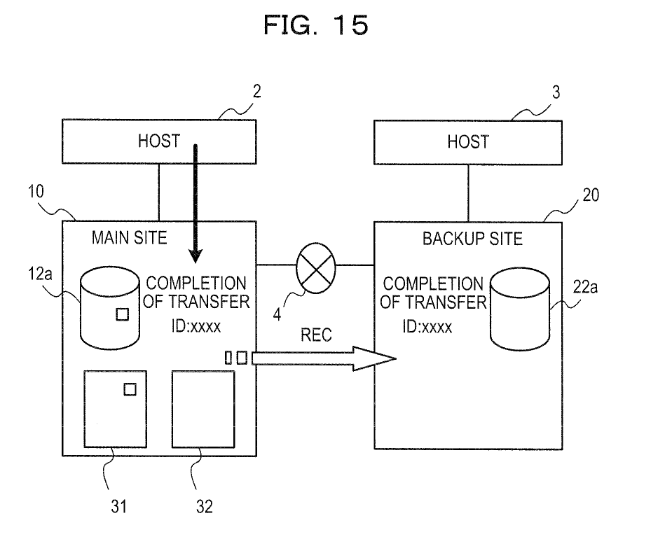

Further, as shown in FIG. 15, upon confirming the completion of the transfer up to the check point, the software in the host 2 writes information to a management file that represents the copy state and that is managed by the copy control unit 30a, thus updating the management file. The management file is a file allowing the software in the host 2 or the host 3 to confirm the copy situation.

Also, the disk array device 10 executes data update by regarding, as copying of ordinary data, the update of the management file made by the software in the host 2.

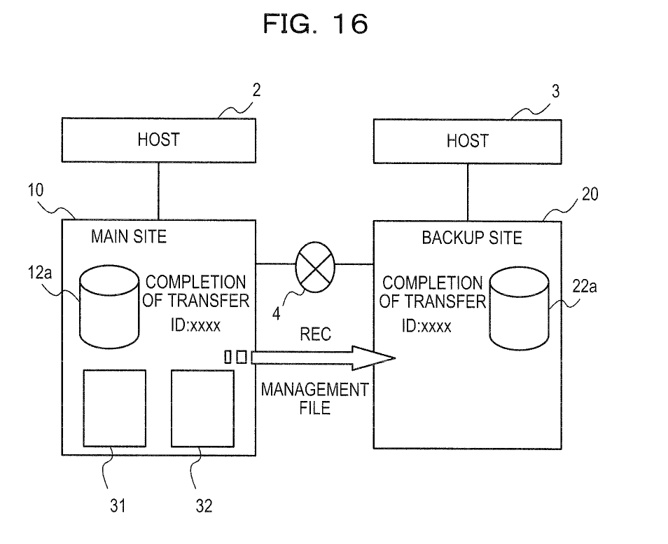

In addition, as shown in FIG. 16, the transfer control section 34a transfers information of the management file updated by the host 2 to the disk array device 20 with the REC. At this point in time, software in the host 3 can ensure arrival (receipt) of a transfer file and the management file to the disk array device 20.

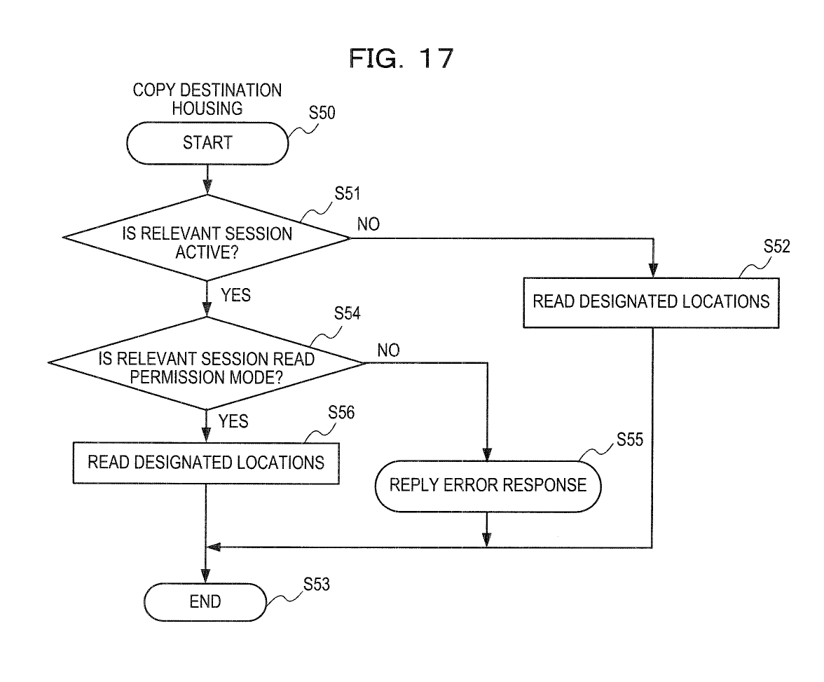

With reference to a flowchart (operations S50 to S56) shown in FIG. 17, a description is next made of the operation procedure(s) of the present storage system 1a when a read request is issued from the host 3 to the disk array device 20 for the copy destination storage area 22a in the state during copying.

Hitherto, a read operation associated with the copy session at the copy destination during the copy operation (during a period in which the status information is in the first status) is inhibited (namely, such a read causes an error response) for the reason that the read is not ensured because of the state during the copy operation.

In contrast, the present storage system 1a permits the read at the copy destination to be executed by the host 3 because locations where the software in the host 3 can read data is ensured due to the completion of transfer of the check point.

Because of the necessity of the copy session using the check point, however, a read operation associated with the copy destination storage area 22a by the host 3 is permitted only when the copy control unit 30a in the disk array device 10 prepares the copy session in a copy-destination read permission mode designated by the host 2.

More specifically, when the CM 21 of the disk array device 20 receives a read request from the host 3 (operation S50), the CPU 26 determines whether the status information of the relevant session is in the first status (during transfer) (operation S51).

If the relevant session is not during copying (NO route of operation S51), the CPU 26 causes the host 3 to read the designated locations (operation S52), following which the process with respect to the read request is brought to an end (operation S53).

On the other hand, if the relevant session is during copying (YES route of operation S51), the CPU 26 determines whether the relevant session is prepared in the copy-destination read permission mode (operation S54).

The relevant session information is information that is prepared by the update control section 33a in accordance with the instruction, received in the above-described operation S1 of FIG. 3 from the host 2, for preparing the remote copy session, and that is then transmitted from the transfer control section 34a.

If the relevant session is not prepared in the copy-destination read permission mode (NO route of operation S54), the CPU 26 replies an error response to the host 3 because the relevant session is during copying (operation S55), following which the process is brought to an end (operation S53).

On the other hand, if the relevant session is prepared in the copy-destination read permission mode (YES route of operation S54), the CPU 26 causes the host 3 to read the designated locations (operation S56), following which the process is brought to an end (operation S53).

With the storage system 1a according to an embodiment of the present invention, as described above, the first bitmap 31 used before the reception of the check point and the second bitmap 32 used after the reception of the check point are prepared. The transfer control section 34a executes data transfer in accordance with a copy instruction from the host 2 on the basis of the first bitmap 31, and when the check point is applied from the host 2, the update control section 33a controls update of the copy source storage area 12a by using the second bitmap 32 instead of the first bitmap 31.

Therefore, when data is copied between the plural disk array devices 10 and 20 for duplexing of the data, a guarantee of the copied data can be reliably ensured on the basis of the check point. Hence, recovery can be easily performed in the event of a failure, etc.

Also, with the present storage system 1a, since the copy process (data transfer) is executed on the basis of the first bitmap 31 and the second bitmap 32, the copy process can be executed in an asynchronous relation to the I/O's from the host, and the data transfer can be performed without being affected by the line condition. Further, since there is no need of using a buffer dedicated for the copy process, which is required in the known consistency mode, intricacy in system design is not required.

Stated another way, since the copy process is executed in the stack mode, the present storage system 1a can provide the above-described advantages of the stack mode as they are, i.e., the advantages that because the copy process functions in an asynchronous relation to the host I/O's, where the buffer is not required and the data transfer is not affected by the line condition.

In addition, since the present storage system 1a includes the two bitmaps 31 and 32 and uses them as described above, it can confirm, with the aid of the check point, the completion of transfer up to the application (reception) of the check point. As a result, recovery in the event of a failure, etc. can be easily executed on the basis of a completion report with respect to the check point.

More specifically, since the update control section 33a updates the first bitmap 31 corresponding to update of data before the reception of the check point, and updates the second bitmap 32 corresponding to update of data after the reception of the check point, the process using the check point can be reliably executed.

Also, when an update instruction is issued again for the copy source storage area 12a after the reception of the check point, the update control section 33a executes an update process for the copy source storage area 12a while corresponding locations in the second bitmap 32 are maintained as they are without updating those locations. This means that data at the time of receiving the check point is not duplicated for the relevant updated locations, but the copy process of data updated by the update process is reliably performed. Thus, the copy process for the copy source storage area 12a can be reliably executed without needing complicated control.

Further, since the update control section 33a manages the status information and, upon receiving the transfer situation confirmation command from the host 2, the status information notifying section 35 replies a response regarding the transfer situation (such as during transfer or after the completion of transfer) to the host 2 on the basis of the status information, the host 2 can reliably confirm the transfer situation.

Still further, when the check point is received during the copying in accordance with the copy instruction from the host 2, the update control section 33a merges the information in the second bitmap 32 into the first bitmap 31 and then initializes the second bitmap 32. Therefore, the copy control unit 30a can reliably execute the processing in relation to the check point.

Next, a storage system 1b according to an embodiment of the present invention (hereinafter referred to as a “present storage system 1b”) is described with reference to the block diagrams shown in FIGS. 1 and 2. The present storage system 1b is constituted similarly to the above-described storage system 1a except for a processing executed by an update control section 33b and a transfer control section 34b of a copy control unit 30b.

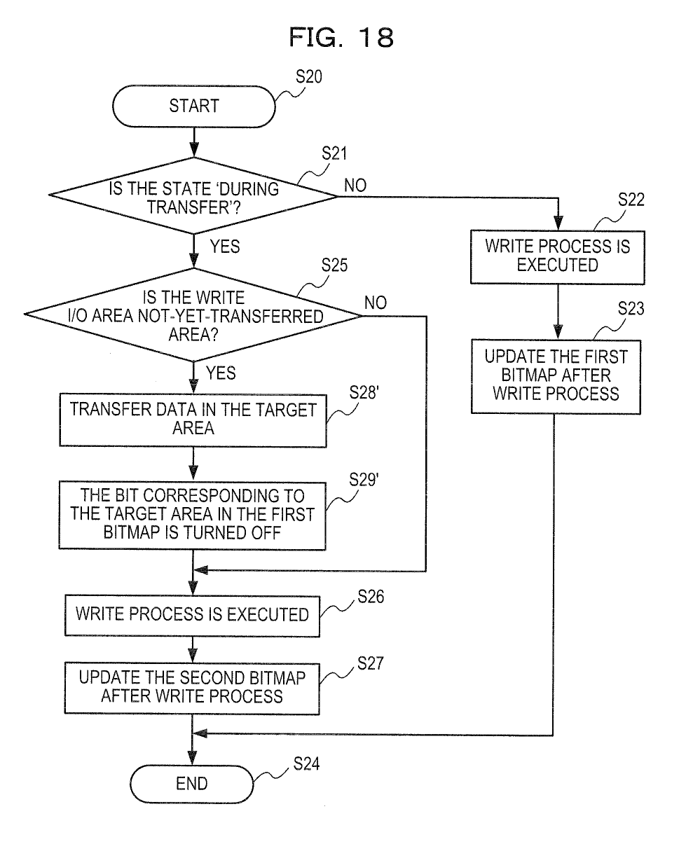

Therefore, the processing executed by the update control section 33b and the transfer control section 34b of the copy control unit 30b will be described in detail below with reference to FIG. 18.

Specifically, the present storage system 1b is constituted as follows. When an update request (write I/O) is issued again from the host 2 for the copy source storage area 12a after the reception of the check point, the transfer control section 34b preferentially transfers update target data in the copy source storage area 12a to the disk array device 20 and the CPU 16 then executes the relevant update request. After the relevant update request is executed, the update control section 33b updates corresponding data in the second bitmap 32 to “1”.

With reference to a flowchart (operations S20 to S27, S28′ and S29′) shown in FIG. 18, a description is now made of the operation procedure(s) of the copy control unit 30b when data is updated with the write I/O for the copy source storage area 12a in the status during transfer (first status). Note that the same characters as those mentioned above denote the same or substantially the same processes, and therefore a detailed description of those processes is omitted here.

If the process is during the data transfer in accordance with the copy instruction from the host 2 and the update control section 33b determines that the write I/O received by the CM 11 does not belong to the not-yet-transferred area (NO route of operation S25), the CPU 16 of the CM 11 sends a write instruction to the host 2, thus causing a write process to be executed (operation S26), and the update control section 33b updates corresponding bitmap data in the second bitmap 32 to “1” (operation S27), following which the process for the write I/O is brought to an end (operation S24).

On the other hand, if the write I/O from the host 2 is instructed for a portion of the copy source storage area 12a corresponding to an area of the first bitmap 31, which is surrounded by a broken line Z, for example, in FIG. 7B and which has data of “1”, the update control section 33b determines on the basis of the first bitmap 31 that the target area of the write I/O is a not-yet-transferred area because bitmap data corresponding to the target area of the write I/O is “1” (YES route of operation S25).

At that time, the transfer control section 34b preferentially transfers data in the target area of the write I/O to the disk array device 20 (operation S28′).

Then, the update control section 33b updates data in the first bitmap 31 corresponding to the target area to be off (“0”) (operation S29′).

Thereafter, the CPU 16 of the CM 11 sends a write instruction to the host 2, thus causing the host 2 to execute the write process of the write I/O (operation S26), and the update control section 33b updates corresponding bitmap data in the second bitmap 32 to “1” (operation S27), following which the process for the write I/O Is brought to an end (operation S24).

Thus, with the storage system 1b according to this embodiment of the present invention, in addition to working advantages similar to those obtained with the above-described embodiment, when a write I/O is issued for a not-yet-transferred portion of the copy source storage area 12a after the reception of the check point, the transfer control section 34a transfers data in the not-yet-transferred portion and the CPU 16 executes the write I/O. Further, the update control section 33b updates the second bitmap 32 corresponding to the write I/O. Therefore, the copy process for the copy source storage area 12a before the reception of the check point can be executed with higher reliability.

It is to be noted that the present invention is not limited to the above-described embodiments and the present invention can be practiced in variously modified forms within the scope not departing from the gist of the present invention.

For example, the foregoing embodiments have been described in connection with the case where the number of the CMs 11 in the disk array device 10 is the same as the number of the CMs 21 in the disk array device 20. However, the numbers of the CMs 11 and the CMs 12 are not limited to particular values in the present invention.

Also, the foregoing embodiments have been described in connection with the case where the copy process is executed between the disk array devices 10 and 20 in accordance with the copy instruction from the host 2. However, the present invention is not limited to that case, and it can be of course applied to a copy process between different storage volumes within the same housing. Such a modification can also provide working advantages similar to those obtained with the above-described embodiments.

The functions of the above-described copy control units 30a and 30b (specifically, the update control sections 33a and 33b, the transfer control sections 34a and 34b, and the status information notifying section 35) may be realized with a computer (including a CPU, an information processing apparatus, a specialized device, and various types of terminals) executing a predetermined application program (copy control program).

The program may be provided, for example, in the form recorded on a computer-readable recording medium, such as a flexible disk, CD (e.g., CD-ROM, CD-R or CD-RW), DVD (DVD-ROM, DVD-RAM, DVD-R, DVD-RW, DVD+R or DVD+RW). In such a case, the computer reads the copy control program from the recording medium and transfers it to an internal storage device or an external storage device to be loaded therein for use. Further, the program may be recorded on, e.g., a storage device (recording medium), such as a magnetic disk, an optical disk or a magneto-optical disk, and may be provided from the storage device to the computer via a communication line.

Herein, the term “computer” represents the concept including hardware and an OS (Operating System) and refers to hardware operating under control of the OS. Also, when hardware is operated with the application program alone without using the OS, the hardware reference may correspond to the computer. The hardware includes at least a microprocessor such as a CPU, and a means for reading a computer program recorded on the recording medium.

The application program as the above-mentioned copy control program includes program code causing the above-mentioned computer to realize operation(s) including the functions of the copy control units 30a and 30b. Further, a part of those functions may be realized with the OS instead of the application program. Although some operations are described herein as being implemented via hardware component, the present invention is not limited to any specific implementation of an operation.

The recording medium used in the embodiments can be selected from among various computer-readable media including, in addition to the above-mentioned flexible disk, CD, DVD, magnetic disk, optical disk, and magneto-optical disk, an IC card, a ROM cartridge, a magnetic tape, a punched card, an internal storage device (memory such as RAM or ROM) in a computer, an external storage device or the like, a print on which a barcode or other code is printed, etc.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A storage system for copying data stored in a first volume, which is connected to a higher-level device, to a second volume, the storage system comprising:
an update control section controlling an update with respect to the first volume in accordance with an update instruction for the first volume from the higher-level device using a first management table for managing an update situation of the first volume during a period from reception of a copy instruction from the higher-level device to reception of a predetermined command; and
a transfer control section transferring update data of the first volume to the second volume based on the update situation in the first management table, and
where the update control section controls, upon receiving the predetermined command, the update with respect to the first volume using, instead of the first management table, a second management table for managing an update situation of the first volume after the reception of the predetermined command.

2. The storage system according to claim 1, wherein, when the update with respect to the first volume is performed before the reception of the predetermined command, the update control section updates a location in the first management table corresponding to an updated location in the first volume, and
when the update with respect to the first volume is performed after the reception of the predetermined command, the update control section updates a location in the second management table corresponding to the updated location in the first volume.

3. The storage system according to claim 1, wherein when another update instruction is issued with respect to a transfer target area of the first volume after the reception of the predetermined command, the update control section executes an update process with respect to the transfer target area of the first volume while a location in the second management table corresponding to the updated location in the first volume is maintained the same.

4. The storage system according to claim 1, wherein when another update instruction is issued with respect to a transfer target area of the first volume after the reception of the predetermined command, the update control section executes an update process with respect to the first volume and updates a location in the second management table corresponding to the updated location in the first volume after the transfer control section has transferred data in the transfer target area to the second volume.

5. The storage system according to claim 1, wherein a management table includes status information, and
the update control section changes the status information to a first status upon receiving the predetermined command and changes the status information to a second status when the transfer based on the first management table is completed.

6. The storage system according to claim 5, comprising:
a status information notifying section providing a response regarding a transfer situation to the higher-level device based on the status information upon receiving a transfer situation confirmation command from the higher-level device.

7. The storage system according to claim 6, wherein upon receiving the predetermined command from the higher-level device during a period in which the status information indicates the first status, the update control section merges information in the second management table into the first management table and initializes the second management table.

8. A copy control method for a storage system for copying data stored in a first method comprising:
controlling an update with respect to the first volume in accordance with an update instruction for the first volume from the higher-level device using a first management table for managing an update situation of the first volume during a period from reception of a copy instruction from the higher-level device to reception of a predetermined command, and
transferring update data of the first volume to the second volume based on the update situation in the first management table, and
where the controlling of the update, upon receiving the predetermined command, includes controlling the update with respect to the first volume using, instead of the first management table, a second management table for managing an update situation of the first volume after the reception of the predetermined command.

9. The copy control method for the storage system according to claim 8, wherein the controlling in implemented such that when the update with respect to the first volume is performed before the reception of the predetermined command, a location in the first management table corresponding to an updated location in the first volume is updated, and
when the update with respect to the first volume is performed after the reception of the predetermined command, a location in the second management table corresponding to the updated location in the first volume is updated.

10. The copy control method for the storage system according to claim 8, wherein when another update instruction is issued with respect to a transfer target area of the first volume after the reception of the predetermined command, an update process with respect to the transfer target area of the first volume is executed while a location in the second management table corresponding to the updated location in the first volume is maintained the same.

11. The copy control method for the storage system according to claim 8, wherein when another update instruction is issued with respect to a transfer target area of the first volume after the reception of the predetermined command, an update process with respect to the first volume is executed and the second management table is updated after data in the transfer target area has been transferred to the second volume.

12. The copy control method for the storage system according to claim 8, wherein status information included in a management table is changed to a first status upon receiving the predetermined command and the status information is changed to a second status when the transfer based on the first management table is completed.

13. The copy control method for the storage system according to claim 10, comprising:
providing a response regarding a transfer situation to the higher-level device based on status information upon receiving a transfer situation confirmation command from the higher-level device.

14. The copy control method for the storage system according to claim 13, wherein upon receiving the predetermined command from the higher-level device during a period in which the status information indicates the first status, information in the second management table is merged into the first management table and the second management table is initialized in the controlling of the update.

15. A copy control unit in a storage system for copying data stored in a first volume, which is connected to a higher-level device, to a second volume, the copy control unit comprising:
an update control section controlling an update with respect to the first volume in accordance with an update instruction for the first volume from the higher-level device using a first management table for managing an update situation of the first volume during a period from reception of a copy instruction from the higher-level device to reception of a predetermined command; and
a transfer control section transferring update data of the first volume to the second volume based on the update situation in the first management table, and
where the update control section controls, upon receiving the predetermined command, the update with respect to the first volume using, instead of the first management table, a second management table for managing an update situation of the first volume after the reception of the predetermined command.

16. The copy control unit in the storage system according to claim 15, wherein when the update with respect to the first volume is performed before the reception of the predetermined command, the update control section updates a location in the first management table corresponding to an updated location in the first volume, and
when the update with respect to the first volume is performed after the reception of the predetermined command, the update control section updates a location in the second management table corresponding to the updated location in the first volume.

17. The copy control unit in the storage system according to claim 15, wherein when another update instruction is issued with respect to a transfer target area of the first volume after the reception of the predetermined command, the update control section executes an update process with respect to the transfer target area of the first volume while a location in the second management table corresponding to the updated location in the first volume is maintained the same.

18. The copy control unit in the storage system according to claim 15, wherein when another update instruction is issued with respect to a transfer target area of the first volume after the reception of the predetermined command, the update control section executes an update process with respect to the first volume and updates a location in the second management table corresponding to the updated location in the first volume after the transfer control section has transferred data in the transfer target area to the second volume.

19. The copy control unit in the storage system according to claim 15, wherein a management table includes status information, and
the update control section changes the status information to a first status upon receiving the predetermined command and changes the status information to a second status when the transfer based on the first management table is completed.

20. The copy control unit in the storage system according to claim 19, comprising:
a status information notifying section providing a response regarding a transfer situation to the higher-level device based on the status information upon receiving a transfer situation confirmation command from the higher-level device.

21. The storage system according to claim 20, wherein upon receiving the predetermined command from the higher-level device during a period in which the status information indicates the first status, the update control section merges information in the second management table into the first management table and initializes the second management table.

22. A computer implemented method of controlling copying of data, comprising:
receiving a request for data transfer between a first volume and a second volume; and
controlling the data transfer by switching between using a first table and a second table based on whether the request is received prior or subsequent to a predetermined command, where the first table and the second table are merged after said controlling.
